(19) United States
(12) Patent Application Publication
(10) Pub. No.: US 2018/0319698 A1
(43) Pub. Date: Nov. 8, 2018

(54) PROCESS FOR PRODUCING A GLASS TUBE HAVING A CROSS SECTION THAT DEVIATES FROM A CIRCULAR SHAPE BY REFORMING

(71) Applicant: SCHOTT AG, Mainz (DE)

(72) Inventors: Markus Riedl, Mitterteich (DE); Jonas Zeitler, Mitterteich (DE); Konrad Kolb, Leonberg (DE); Wolfgang Kreger, Leonberg (DE); Gottfried Haas, Tirschenreuth (DE)

(73) Assignee: SCHOTT AG, Mainz (DE)

(21) Appl. No.: 15/964,106

(22) Filed: Apr. 27, 2018

(30) Foreign Application Priority Data
May 5, 2017 (DE) 10 2017 207 572.4

(51) Int. Cl. C03B 23/049

(52) U.S. Cl. CPC C03B 23/049

(57) ABSTRACT

The present invention relates to a process for producing a glass tube having a cross section that deviates from a circular shape by reforming with high precision and quality of the surface. Furthermore, the invention relates to the use of this process for producing housings for mobile electronic devices. The process comprises at least provision of a glass tube, heating of the glass tube, provision of at least one reforming tool, where the reforming tool is suitable for exerting a compressive force on the heated glass tube, provision of an inner mandrel which comprises at least one open-pored material, insertion of at least one section of the inner mandrel into the glass tube and forming of the glass tube by application of a compressive force perpendicular to the longitudinal axis of the glass tube, where the compressive force is exerted by the reforming tool and acts on the outer surface of the glass tube and where the glass tube does not rotate around its longitudinal axis.

This application claims priority of German patent application DE 10 2017 207 572.4.

### TECHNICAL FIELD OF THE INVENTION

The present invention relates to a process for producing a glass tube having a cross section that deviates from a circular shape by reforming with high precision and quality of the surface. Furthermore, the invention relates to the use of this process for producing housings for mobile electronic devices.

### BACKGROUND OF THE INVENTION

### Field of the Invention

Many applications for glass tubes having a cross section that deviates from a circular shape are known from the prior art. Such applications have different requirements in terms of the dimensions of the tubes, the cross-sectional geometry or the quality of the surface. In addition, such glass tubes must be manufactured inexpensively and with appropriate precision and reproducibility.

In the shaping of glass tubes, a distinction is made in principle between continuous and discontinuous processes. Owing to the usually fundamentally different process parameters, principles employed in continuous production processes cannot easily be applied, or cannot be applied at all, to discontinuous processes, so that they cannot serve as starting point for a person skilled in the art for improving discontinuous production processes.

### Description of the Related Art

DE 10 2004 060 409 A1 by the applicant describes a process for redrawing cast glass tubes for producing glass tubes having a cross section of virtually any desired shape. For this purpose, the tube, which has previously been cast to produce a desired shape and cut to length is clamped in a holding device, partially heated and then drawn to the desired external diameter. However, the manufacturing tolerances of this process depend, inter alia, greatly on the constancy of the drawing speed.

WO 2016/123315 A1, on the other hand, describes a process for reforming glass tubes with high precision and quality of the surface by applying pressure perpendicular to the longitudinal axis of the glass tube. However, the process described there has the disadvantage that it requires to set the gas pressure in the interior of the glass tube in a complicated manner to a value that depends on the desired shape and the thermal properties of the glass composition used.

### SUMMARY OF THE INVENTION

It is therefore an object of the present invention to overcome the disadvantages of the prior art and provide a process for producing glass tubes having a cross section that deviates from a circular shape with high precision and quality of the surface, which process is suitable for inexpensive production for large numbers of pieces.

The invention achieves this object in a surprisingly simple way by means of a process according to claim 1 and by a use according to claim 12. Advantageous embodiments and further developments of the invention are indicated in the dependent claims.

These and other aspects and objects, features and advantages of the present invention will become apparent upon a consideration of the following detailed description and the invention when read in conjunction with the drawing Figures.

It is to be understood that both the foregoing general description and the following detailed description are merely exemplary of the invention, and are intended to provide an overview or framework for understanding the nature and character of the invention as claimed.

### DESCRIPTION OF THE DRAWINGS

The invention will be illustrated below with reference to the accompanying drawings, from which further features and advantages can be derived. The drawings schematically show:

FIG. 1a a glass tube, an inner mandrel and two reforming tools before commencement of the forming of the glass tube by the reforming tool in a section along the longitudinal axis of the glass tube.

FIG. 1b the glass tube, the inner mandrel and the reforming tools as per FIG. 1a at the end of the forming of the glass tube by the reforming tool in a section along the longitudinal axis of the glass tube.

FIG. 2a the glass tube, the inner mandrel and the reforming tools as per FIG. 1a before commencement of the forming of the glass tube by the reforming tool in cross section perpendicular to the longitudinal axis of the glass tube.

FIG. 2b the glass tube, the inner mandrel and the reforming tools as per FIG. 1b at the end of the forming of the glass tube by the reforming tool in cross section perpendicular to the longitudinal axis of the glass tube.

FIG. 3a to d four examples of glass tubes that can be produced by reforming according to the invention in plan view onto the cross section.

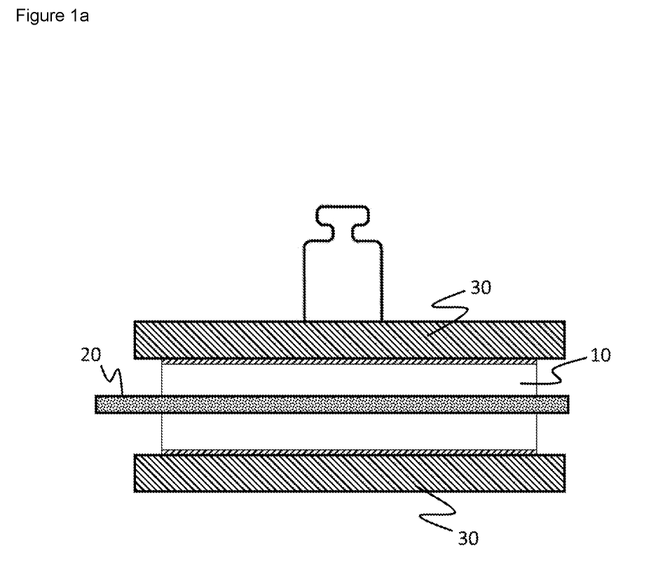

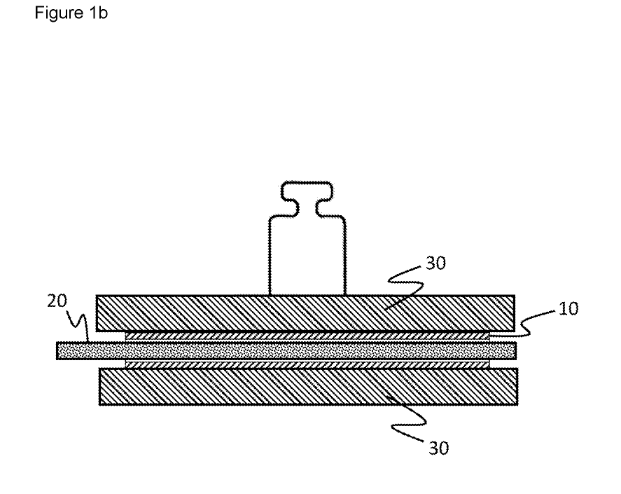

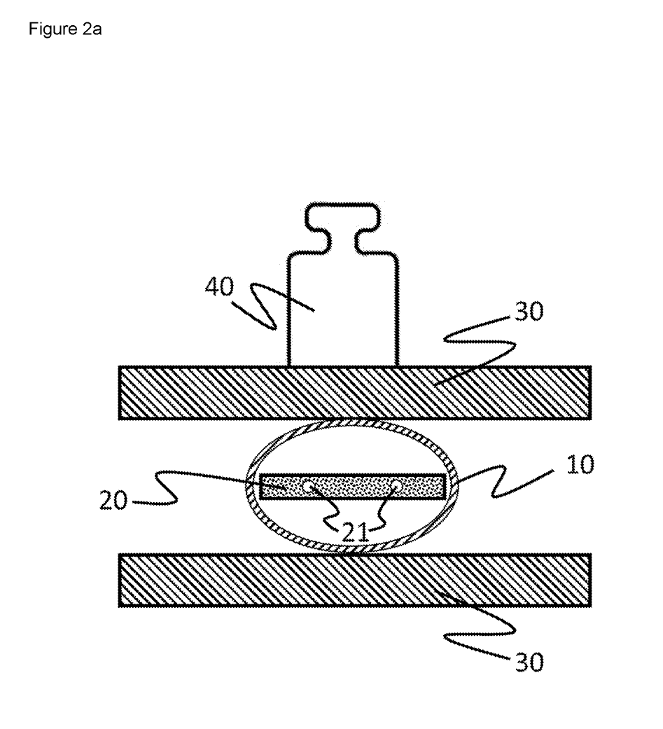

FIG. 1a schematically shows, in a section along the longitudinal axis of the heated glass tube (10), an inner mandrel (20) and two plate-like reforming tools (30).

### DETAILED DESCRIPTION OF THE INVENTION

The reforming tools (30) are each arranged in such a way that they are movable perpendicular to the longitudinal axis of the glass tube (10) and thus can exert a compressive force perpendicular to the longitudinal axis of the glass tube (10) onto the glass tube (10) by being moved towards each other. The weight (40), which is likewise shown schematically, symbolizes this exertion of force by the reforming tools (30) on the glass tube (10).

The inner mandrel (20) can be inserted into the glass tube (10) in such a way that it protrudes from the glass tube (10) at both ends of the tube. It comprises an open-pored material, for example, isostatically pressed graphite. Furthermore, its surface is mirror polished.

The glass tube (10) can be shorter in the direction of its longitudinal axis than the reforming tools (30) and the inner mandrel (20), so that the tube (10) can be reformed over its entire length without unformed peripheral regions of the tube (10) remaining at its ends.

The forming bodies (30) can likewise comprise isostatically pressed graphite or other materials that are sufficiently heat-resistant, e.g. porous ceramics or metals. The surfaces of the reforming tools (30) which are in contact with the glass tube (10) can be likewise polished to a mirror finish.

Furthermore, the glass tube (10) can be placed on a support during heating, during forming or for the purpose of transport. Such a support can likewise be mirror polished. Furthermore, it can comprise open-pored material, in particular the part that is in contact with the glass tube (10), so that a gas cushion between the glass tube (10) and the support can be formed.

FIG. 1b shows the glass tube (10), the inner mandrel (20) and the reforming tools (30) as per FIG. 1a at the end of forming by the reforming tools (30). The reforming tools (30) have been moved towards each other perpendicular to the longitudinal axis of the glass tube (10), so that they have pressed together the glass tube (10) and thus exerted a compressive force on the glass tube (10) perpendicular to the longitudinal axis thereof.

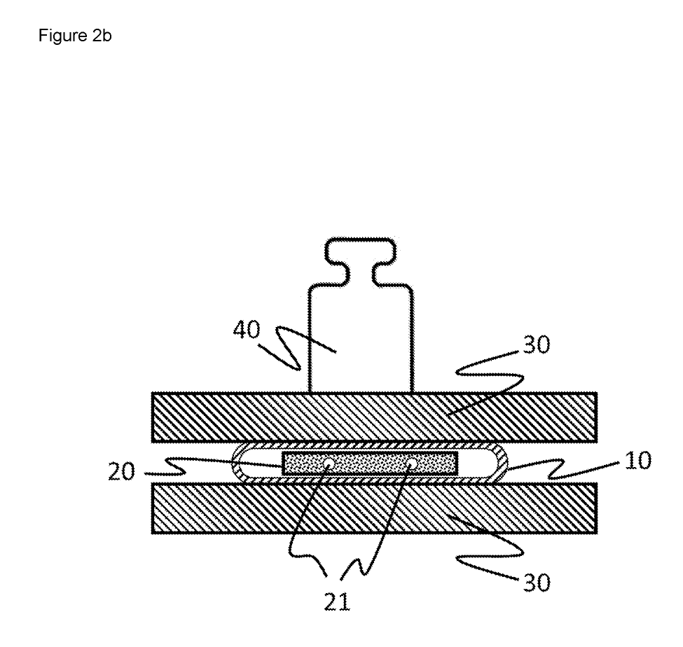

FIGS. 2a and 2b each show the same example as in FIGS. 1a and 1b but in a cross section perpendicular to the longitudinal axis of the glass tube (10). It is apparent from these figures that the inner mandrel (20) can have two hollow structures (21) in the form of holes along its length in its interior for more uniform distribution of the gas pressure. Through these holes, technical-grade nitrogen can be introduced into the inner mandrel (20) by means of, for example, a diaphragm pump or a rotary pump.

It can be seen from FIG. 2a that the glass tube (10) has an elliptical cross section before commencement of forming. The aspect ratio of the cross section depicted is about 1.6:1.

FIG. 2b shows the cross section of the tube (10) after reforming, which results from the selection of the cross-sectional geometry of the reforming tools (30) and of the inner mandrel (20). This resulting cross section of the reformed glass tube (10) corresponds to an oval cross section having two parallel, flat side sections and two rounded peripheral regions. The aspect ratio is about 6.4:1.

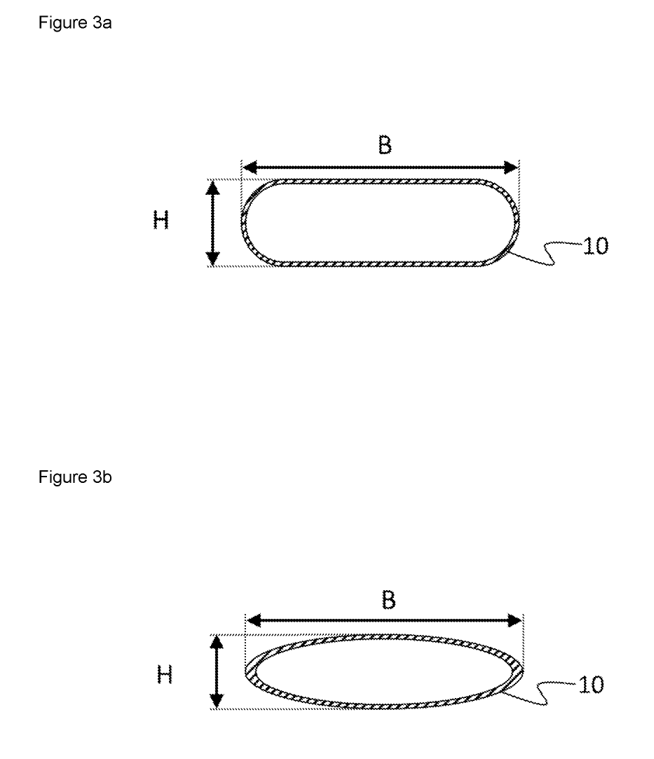

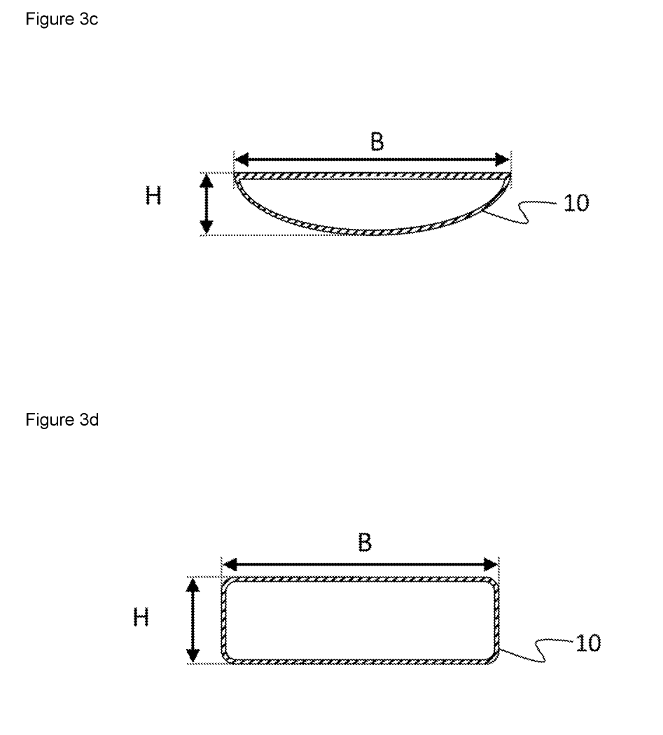

FIGS. 3a to 3d show various examples of glass tubes having a cross section deviating from a circular shape. Such tubes can be produced with high precision and high throughput by means of the process according to the invention. The respective aspect ratio of the glass tubes depicted is given by the ratio of the width B to the height H.

FIG. 3a shows the cross section of a glass tube (10) that has the same general shape as that in FIG. 2b. The oval glass tube (10) has two parallel, flat longitudinal sides and two semi-circular rounded peripheral regions and in terms of its shape is reminiscent of the running track of a sports field. The wall thickness is constant over the entire circumference.

FIG. 3b shows a glass tube (10) having an elliptical cross section. The wall thickness of such an elliptical tube (10) can be constant over the entire circumference or, as depicted in FIG. 3b, vary continually and mirror-symmetrically.

FIG. 3c shows a glass tube (10) which has a flat longitudinal side and a convex side, with the radii of curvature being very small in the two corner regions. The wall thickness is constant in the region of the flat longitudinal side.

FIG. 3d shows a glass tube (10) having an essentially rectangular cross section and rounded corners. The wall thickness is constant over the entire circumference.

### Detailed Description of Preferred Embodiments

According to the present invention, a process for producing a glass tube having a cross section that deviates from a circular shape by reforming can comprise at least the steps:
providing a glass tube (10) having a longitudinal axis, an inner surface and an outer surface,
heating of the glass tube (10),
providing at least one reforming tool (30), where the reforming tool (30) is suitable for exerting a compressive force on the outer surface of the heated glass tube (10),
providing an inner mandrel (20) which comprises at least one open-pored material,
inserting at least a section of the inner mandrel (20) into the glass tube (10) and
forming the heated glass tube (10) by application of a compressive force perpendicular to the longitudinal axis of the glass tube (10), where the compressive force is exerted by the reforming tool (30) and acts on the outer surface of the glass tube (10) and where the glass tube (10) does not rotate around its longitudinal axis.

According to the invention, the cross section of a glass tube is the shape of the external contour of the glass tube that is given by cutting through the glass tube along a plane that is perpendicular to the longitudinal axis of the glass tube. Thus, for example, a glass tube that is configured as a hollow cylinder has a circular cross section and all points on the surface of the glass tube have the same distance from the longitudinal axis. In the case of a glass tube whose cross section deviates from a circular shape, points on the surface thereof generally do not all have the same distance from the longitudinal axis.

Thus, the aspect ratio of the cross section can be defined as the ratio of the extension of the cross section in the direction of its greatest extension to the extension of the cross section in the direction perpendicular thereto. In the case of a glass tube having a circular cross section, this aspect ratio assumes the value 1. In the case of a glass tube having an elliptical cross section, it corresponds to the ratio of the semi-major axis to the semi-minor axis. In the case of a rectangular cross section, it corresponds to the ratio of the width to the height, assuming that the width of the rectangle is greater than or equal to its height.

According to the invention, as a first step glass tubes are being provided. As starting material for these tubes, it is in principle possible to use any glass composition from which glass tubes can be produced, i.e., for example, soda-lime silicate glass, borosilicate glass or aluminosilicate glass. Such glasses are marketed, inter alia, under the names AR-Glas®, DURAN® or SCHOTT 8252. For applications that have particular requirements in terms of the mechanical stability, as is the case, for example, for housings of mobile electronic devices, the use of glass compositions having an increased fracture toughness or of glass compositions that can be chemically toughened is preferred. Glass tubes can optionally be cleaned before being provided, in order, for example, to remove particles from the surface, which particles could have adverse effects on the surface quality during reforming.

The process of the invention is particularly suitable for reforming glass tubes having a maximum extension in the cross section of from 5 to 200 mm and a length along the longitudinal axis of from 50 to 300 mm. However, it is also possible to reform longer tubes and subsequently cut them into tube sections having the desired dimensions. The tubes or tube sections after reforming and optionally cutting up are preferably longer than the final dimension of the product to be produced. This allows working of the edges, for example in the form of a grinding and polishing process. However, the tube sections should also not be longer than is necessary for this purpose, in order to avoid unnecessary waste. The wall thickness of the tubes is preferably in the range from 0.3 to 2.0 mm.

In choosing the cross section of the glass tubes, various possibilities come into consideration. Glass tubes having a circular cross section offer the advantage that they can be manufactured in large quantities and can correspondingly be procured inexpensively. Glass tubes having an elliptical cross section, which comes closer to the desired aspect ratio, can be formed in a shorter time or possibly with fewer steps than tubes having a circular cross section. They thus offer a potential for increasing the throughput of the process. Furthermore, it is also possible to use glass tubes that have a cross section that in another way comes close to the desired cross section, for example glass tubes having a substantially rectangular cross section.

In particular, the process of the invention makes it possible to produce glass tubes having an aspect ratio that is greater than the aspect ratio of the cross section of the glass tube before reforming and is greater than 3:1, preferably greater than 6:1 and particularly preferably greater than 9:1. The aspect ratio can be up to 12:1.

The glass tubes are heated before forming. In an embodiment of the invention, it is sufficient to heat the glass tube to a temperature that corresponds at least to the upper cooling point and not more than the softening point, i.e. to set the viscosity of the glass to a value in the range from 10¹³ dPa s to 10⁷⁶ dPa s. The upper cooling point corresponds to the temperature at which the glass has a viscosity of 10¹³ dPa s. The softening point corresponds to the temperature at which the glass has a viscosity of 10⁷⁶ dPa s. These two temperatures are materials properties and thus depend greatly on the glass composition. The upper cooling point and the softening point can be determined in accordance with the standards of the DIN ISO 7884 series.

The processes of the disclosure are energetically and thus also economically particularly advantageous in comparison with processes in which glass has to be heated to temperatures above the softening point for forming. In addition, heated glass tubes having a viscosity of at least 10^{7.6} dPa s have a greater dimensional stability than at a lower viscosity, which additionally contributes to stabilization of the forming process.

The heating of the glass tubes can be carried out by many different methods. Various heating elements such as electric or fossil fuel-fired furnaces, infrared radiators or lasers can be used for this purpose. In fossil fuel-fired furnaces, it is possible to use, in particular, gas burners operated by the oxy-fuel process. Depending on the heating element, it can be advantageous either to rotate the glass tubes around the longitudinal axis during heating in order to ensure uniform uptake of heat or to fix the glass tubes without rotation on a refractory support. The temperature of the glass tube should preferably be adjusted as homogeneous as possible in order to allow uniform reforming. In particular, the coldest point and the hottest point of the tube should differ in terms of their temperature by not more than 10 K, preferably not more than 5 K.

When using materials that are susceptible to oxidation inside a furnace, it can be advantageous to operate the furnace with an inert or reducing atmosphere.

The reforming tool is suitable for asserting a compressive force on the outer surface of the glass tube perpendicularly to the longitudinal axis of the glass tube, for example by it being moved in the appropriate direction so that the glass tube is pressed against a support or against a second reforming tool. In addition, it comprises a shaped body that has a forming surface for forming the heated glass tube. For the purposes of the invention, the shaped body is thus the part of the reforming tool whose surface comes into contact with the glass tube during reforming.

The surface of the shaped body that comes into contact with the glass tube is referred to as a forming surface for the purposes of the present invention. The forming surface is configured so that it prescribes the cross-sectional geometry of the outer surface of the glass tube after the forming step. For this purpose, it can be shaped in a targeted manner, i.e., for example, be flat or have a curvature. It is preferably polished to a mirror finish in order to avoid undesirable impairment of the glass surface.

Furthermore, an inner mandrel that comprises at least one open-pored material is provided according to the invention. The inner mandrel can be permeable to gases, at least where it consists of open-pored material. It is a particular advantage of this process over processes in which no inner mandrel is used that the interior contour of the glass tube can also be set precisely by means of the inner mandrel. For example, in the case of tube cross sections having flat sections, the parallelism of the interior and exterior surface in the flat section can in this way be set particularly precisely.

For this purpose, it is particularly advantageous for the cross section of the inner mandrel to be matched to the desired cross section of the glass tube. Thus, an inner mandrel can have a rectangular, oval or elliptical cross section.

Furthermore, it is particularly advantageous for a single inner mandrel that is configured as a monolithic component to be provided for the forming step. Compared to the use of a plurality of mandrels or a single mandrel which consists of a plurality of parts which are movable relative to one another, this offers the advantage of reducing the number of movable parts in the apparatus for carrying out the process. It thus contributes to a reduction in the complexity of the process and to an improvement in the economics.

In one embodiment of the invention, the inner mandrel has in its interior at least one hollow structure through which a gas can be introduced into the inner mandrel. The gas flows through the open-pored material to the surface of the inner mandrel. There it forms a gas cushion between the surface of the inner mandrel and the interior surface of the glass tube. The hollow structure serves to distribute the pressure homogenously in the interior of the mandrel. Particularly when using a plurality of hollow structures, these can be arranged so that a gas cushion having an essentially homogeneous thickness is established between the mandrel and the interior surface of the glass tube. Direct contact between the inner mandrel and glass tube can be avoided by means of such a gas cushion. In this way, the risk of contamination or damage of/to the glass tube by the inner mandrel is significantly reduced or even eliminated. When an inner mandrel is used according to the invention, such a gas cushion is particularly advantageous since defects or contamination resulting from contact between inner mandrel and glass surface in the interior of a noncircular tube cannot be removed again or can be removed again only with considerable effort in subsequent processes such as polishing.

Furthermore, it is advantageous that the inner mandrel prevents, inter alia, the glass deforming in an uncontrolled manner under its own weight because of the viscosity that has been lowered by heating. In particular, the formation of an undesirable bone-shaped cross section can be avoided. A bone-shaped cross section has a constriction in the middle that, in particular, has a smaller dimension than the dimension to be achieved in the corresponding direction. Because of this stabilization, glass tubes can thus be formed precisely, in particular, at low viscosity and correspondingly high temperatures.

In one embodiment of the invention, the open-pored material has an open porosity in the range from 1% to 50%, preferably from 10% to 45% and particularly preferably from 15% to 40%. If the inner mandrel comprises a plurality of open-pored materials having different porosities, the porosity of individual materials used for this purpose can even be up to 90%. This is particularly advantageous when the inner mandrel is to have simultaneously a readily polishable surface, a high permeability to gases and a high mechanical stability. In such a case, it can be advantageous to select a thin material having a low porosity as contact material for the glass tube and mechanically stabilize this on the side facing away from the glass tube by means of one or more thicker materials having a higher porosity. It is even possible to use a material having a porosity that decreases in the direction of the forming surface, i.e. having a gradient in the porosity.

The amount of the gas exiting through the open-pored material and thus the thickness of the gas cushion can be adjusted by means of the pressure under which the gas is introduced into the inner mandrel, by selection of the open porosity of the material, by the arrangement of the hollow structures in the inner mandrel and by the thickness of the material thereof. It is particularly advantageous to select these parameters in such a way that a constant thickness of the gas cushion is established along the entire length of the glass tube.

In one embodiment of the invention, the gas introduced into the inner mandrel comprises at least one of the gases nitrogen or argon. Especially when using high forming temperatures and a material that is susceptible to oxidation for the surface of the inner mandrel, it is advantageous for the gas to be either chemically inert or reducing, for example technical-grade nitrogen, technical-grade argon, an H₂/N₂ gas mixture or mixtures thereof.

It has surprisingly been found that the probability of fracture of the glass tube during forming can be reduced when the gas is preheated to a temperature of from 200° C. to 800° C., preferably from 400° C. to 600° C., before introduction into the inner mandrel. The preheating of the gas presumably prevents the formation of stress in the wall of the glass tube.

In a further embodiment of the invention, the open-pored material can comprise graphite, ceramic and/or metal. Examples are glass fibre-reinforced or carbon fibre-reinforced graphite or graphite composite materials, ceramic, metals and metal alloys. The material preferably comprises isostatically pressed graphite. The shaped body can also comprise a plurality of these materials if required, for example for reasons of mechanical stability. When selecting the open-pored material, it should be ensured that it does not react chemically with the glass at the temperatures required for forming.

Before forming, the inner mandrel is inserted at least section wise into the glass tube. The mandrel can protrude from one or both ends of the glass tube or be aligned flush with one or both ends of the glass tube.

In one embodiment of the invention, the shaped body of the reforming tool and the inner mandrel are larger along the longitudinal axis of the glass tube than the glass tube, or at least as large as the glass tube, so that the glass tube can be reformed along its entire length. This prevents the formation of unreformed regions or regions that have not been reformed according to the desired cross-sectional geometry at the ends of the glass tube. Such regions would need to be cut off in a subsequent process step and thus represent waste. Accordingly, reforming of a glass tube along its entire length increases the production efficiency and the efficiency in terms of resource consumption.

After the insertion of the inner mandrel and the heating of the glass tube have been concluded, the heated glass tube is formed by application of a compressive force perpendicular to the longitudinal axis of the glass tube. The compressive force is exerted by the reforming tool and acts on the outer surface of the glass tube. The glass tube does not rotate around its longitudinal axis during forming.

The reforming operation is complete when the glass tube has assumed the desired cross-sectional geometry. This is generally the case when the interior wall of the glass tube, or at least part of it, is in contact with the surface of the inner mandrel or has approached its surface to within a distance corresponding to the thickness of the gas cushion.

Depending on the open-pored material used and the later intended use of the glass tube, it can be advantageous for the surface of the inner mandrel and optionally also the surface of the reforming tool to be polished to a mirror finish, i.e. have a surface roughness in the submicron range. In this way, an average surface roughness of the reformed glass tube of R_{z}<1 μm, measured in accordance with DIN EN ISO 4287, with a very high optical quality can be achieved. At the same time, damage to the surface, such as very fine scratches, resulting from forming, is prevented and the mechanical stability of the reformed glass tube is therefore improved.

The shaped body of the reforming tool can likewise comprise at least one open-pored material and be permeable to gases where it consists of open-pored material. Thus, a gas cushion can be formed between the reforming tool and the outer surface of the glass tube. The open-pored material of the shaped body then has, depending on its porosity and the thickness of the gas cushion to be achieved, a thickness in the range from 0.2 to 4 mm. Furthermore, it can be necessary to stabilize the shaped body mechanically on the side opposite the forming surface by means of ridges, i.e. regions having an increased thickness of the material. As an alternative to stabilization by means of ridges, a shaped body can also comprise a thin material that has been polished to a mirror finish and is mechanically reinforced from the rear side by a thicker material having a higher porosity.

In a further embodiment of the invention, it is also possible for a plurality of reforming steps to be performed. For each of these steps an inner mandrel matched and adapted to the respective forming step can be used. Optionally, specifically adapted reforming tools can be used for each step. Such steps are to be carried out in succession, with the cross section of the glass tube more closely approximating the desired cross section after each reforming step. If desired, the inner mandrel to be used in each case is selected for each further reforming step with a greater aspect ratio than in the previous step. It thus differs in terms of its cross-sectional geometry from the inner mandrel used beforehand in each case.

This separation of the forming operation into a plurality of steps is advantageous particularly when the aspect ratio of the starting tube and the desired aspect ratio differ particularly greatly from one another. This is the case for example, when a starting tube having a circular cross section is to be reformed into a tube with a cross section having an aspect ratio of more than 5:1.

Especially when using starting tubes having a cross section with a low aspect ratio, for example from 1:1 to about 1.5:1, it can be advantageous to add an additional process step before the insertion of the inner mandrel. During such an additional step, a compressive force can be applied perpendicularly to the longitudinal axis of the glass tube, with the compressive force being directed towards the longitudinal axis. Such a step can serve to increase the aspect ratio of the cross section of the glass tube in such a way that an inner mandrel whose width is greater than the greatest extension of the starting glass can be inserted into the glass tube.

Furthermore, additional heating steps or continuous heating can be carried out between two successive reforming steps, for example in order to compensate for cooling of the glass tube during the preceding forming step or in order to set a desired viscosity of the glass for the next forming step.

Such a glass tube can be used for producing a component for a housing of a mobile electronic device, preferably a mobile telephone. This is made possible only by the high aspect ratios and excellent surface qualities of the glass tube that can be achieved by means of the process of the invention.

The entire disclosures of all applications, patents and publications, cited above and below, and of corresponding German application 10 2017 207 572.4 filed May 5, 2017, are hereby incorporated by reference.

The present invention will be illustrated below by a series of examples. However, the present invention is not limited to the examples mentioned.

### Examples

In a first working example, a glass tube (10) made of DURAN® and having an elliptical cross section, a wall thickness of 1.8 mm and a length of 170 mm is provided. In cross section, the tube has a dimension of 65 mm along the major axis (i.e. a semi-major axis of about 32.5 mm) and of 44.9 mm along the minor axis (i.e. a semi-minor axis of about 22.45 mm). The resulting aspect ratio is about 1.45:1. DURAN® is a borosilicate glass that has approximately the following composition in percent by weight on an oxide basis:

| | | |
|---|---|---|
| SiO₂ | 81% | by weight, |
| B₂O₃ | 13% | by weight, |
| Na₂O + K₂O | 4% | by weight and |
| Al₂O₃ | 2% | by weight. |

The upper cooling point of DURAN® is about 560° C., and the softening point is about 825° C.

The glass tube (10) is continuously heated to a temperature of 690° C. in a tunnel furnace. In order to avoid oxidation of the glass contact material, the furnace is flushed with a reducing or inert gas, for example H₂/N₂ gas mixture, nitrogen or argon. The glass tube (10) rests with its outer wall on a transport support during heating. Its semi-major axis is aligned parallel to the surface of the transport support. The region of the transport support that comes into contact with the glass tube (10) consists of isostatically pressed graphite having a surface polished to a mirror finish.

Furthermore, a reforming tool (30) which comprises at least a shaped body and a hollow structure in its interior is provided in the furnace. The shaped body of the reforming tool (30) likewise consists of mirror-polished isostatically pressed graphite. The porosity of the shaped body is 15% and its thickness is 0.5 mm. To stabilize the shaped body mechanically, this body has ridges that are arranged in a honeycomb body and have a thickness of 9.5 mm on its rear side, i.e. on the side facing away from the glass tube and thus facing the interior of the reforming tool. In the interior of the reforming tool, a hollow structure also encompasses the intermediate spaces between the ridges arranged in a honeycomb body. Into this structure, technical-grade nitrogen is introduced, resulting in a gas flow through the open-pored shaped body.

After provision of the reforming tool (30), a rectangular inner mandrel (20) is provided. The inner mandrel has cross-sectional dimensions of 58×4.4 mm² and a length of 200 mm. It consists of isostatically pressed graphite having a porosity of 25%. Its surface is mirror polished. In addition, it has a number of holes having a diameter of 3 mm along its length, through which technical-grade nitrogen is introduced into the inner mandrel to result in a gas flow towards its surface. These holes are arranged so that a uniform thickness of the gas cushion between inner mandrel and the interior wall of the glass tube is established at all places through to the end of reforming.

As soon as the glass tube (10) has reached the target temperature to a precision of ±5 K, it is positioned under the reforming tool (30) in the furnace in such a way that the surfaces of the support, the semi-major axis of the glass tube (10) and the surface of the shaped body are plane-parallel to one another. The temperature of the shaped body corresponds to the temperature in the furnace.

The inner mandrel (20) is then inserted into the glass tube (10). It is aligned in such a way that its side that is longer in cross section (58 mm) is parallel to the semi-major axis of the glass tube (10). The shorter side (4.4 mm) is thus aligned parallel to the semi-minor axis of the glass tube (10). The inner mandrel is inserted into the glass tube (10) to such a depth that it protrudes 15 mm out of the opposite end of the glass tube (10). In this position, the inner mandrel protrudes 15 mm from both ends of the glass tube (10).

In a next step, the reforming tool (30) is moved perpendicular to the longitudinal axis of the glass tube (10) so that the reforming tool (30) exerts a compressive force on the outer surface of the glass tube (10) and presses it against the transport support. Due to the nitrogen flowing through the shaped body, a gas cushion is formed between the shaped body and the glass tube so that the shaped body and the glass tube do not come into direct contact.

The reforming tool (30) is moved until the cross section of the glass tube in the direction of the semi-minor axis, i.e. perpendicular to the surface of the shaped body, attains an external dimension of 8 mm. When the surfaces are configured suitably, precise plane-parallelism of the flat regions of the exterior and internal surfaces of the formed tube (10) can be achieved. In this position, a gas cushion is also formed between the surface of the inner mandrel and the inner surface of the glass tube. This gas cushion and the mirror polished surfaces of the mandrel allow the mandrel to be pulled out of the tube easily and without damage or contamination to/of the tube.

This process results in a reformed glass tube (10) having a height of H=8 mm and a width of B=80 mm, corresponding to an aspect ratio of 10:1. The cross section of the formed glass tube (10) corresponds substantially to the schematic depiction in FIG. 3a.

In a second working example, a glass tube having the same cross section as in the first working example is produced from a glass tube (10) having a circular cross section. Since the aspect ratio is increased here by a factor of 10, it is advantageous to carry out the reforming in two steps using two different inner mandrels. The two inner mandrels are each a rigidly coherent, monolithic component, i.e. a single inner mandrel per reforming step.

As indicated in the first working example, a glass tube (10) made of DURAN® is provided. The glass tube (10) has a circular cross section having an external diameter of 54 mm and a wall thickness of 1.8 mm. The glass tube (10) is 170 mm long.

The glass tube (10) is continuously heated to a temperature of 690° C. in the same tunnel furnace that is flushed with an inert gas. The tube rests on the same transport support as in the first working example.

The reforming tool provided is likewise identical to that in the first working example.

The first inner mandrel provided differs from the inner mandrel described in the first working example in the dimensions of its cross section and the arrangement of the holes. This first inner mandrel has a rectangular cross section with a width of 42 mm and a height of 18.6 mm. The arrangement of the holes for distribution of the gas is adapted such that a gas cushion having a constant thickness is formed between inner mandrel and wall of the glass tube through to the end of the first reforming step.

As soon as the glass tube (10) has reached the target temperature to a precision of ±5 K, it is positioned on the reforming tool (30) in the furnace in such a way that the surfaces of the support and of the shaped body are plane-parallel to one another. The temperature of the shaped body corresponds to the temperature in the furnace.

The first inner mandrel (20) is then inserted into the glass tube (10). Here, the inner mandrel is aligned so that its broad side (42 mm) is aligned parallel to the shaped body and support and the shorter side (16.6 mm) is thus aligned perpendicular thereto. The inner mandrel is inserted into the glass tube (10) to such a depth that it projects 15 mm out from the opposite end of the glass tube (10). In this position, the inner mandrel thus projects 15 mm from both ends of the glass tube (10).

In a next step, the reforming tool (30) is moved perpendicular to the longitudinal axis of the glass tube (10) so that the reforming tool (30) exerts a compressive force on the outer surface of the glass tube (10) and presses it against the transport support, with a gas cushion being formed between shaped body and glass tube.

The reforming tool (30) is moved until the cross section of the glass tube attains an external dimension of about 22.2 mm in the direction perpendicular to the surface of the shaped body. When the surfaces are configured suitably, precise plane-parallelism of the flat regions of the exterior and interior surfaces of the formed tube (10) can be achieved. A gas cushion is likewise formed between inner mandrel and glass tube.

This first reforming step thus results in a reformed glass tube (10) having a height of H=22.2 mm and a width of B=72.2 mm, corresponding to an aspect ratio of about 3.3:1. The cross section of the reformed glass tube (10) corresponds substantially to the schematic depiction in FIG. 3a.

To prepare for the second forming step, the reforming tool (30) is removed and the first inner mandrel (20) is withdrawn from the glass tube (10). The gas cushion facilitates this. If the glass tube (10) has cooled down during forming, it is reheated to a temperature of 690° C. When a preheated reforming tool (30) and preheated process gases are used for forming the gas cushion, this step of reheating either can be omitted entirely or at least be kept short.

For the next reforming step, a second inner mandrel (20) which is of the same type as the first inner mandrel (20) but has a width of 65 mm and a height of 4.4 mm is provided. The positions of the hollow structures in the interior of the inner mandrel is once again matched to the gas cushion to be achieved.

The second inner mandrel (20) is then inserted into the glass tube (10). The inner mandrel is aligned so that its broad side (65 mm) is aligned parallel to the shaped body and support. The shorter side (4.4 mm) is thus aligned perpendicular thereto. The inner mandrel is inserted into the glass tube (10) to such a depth that it protrudes 15 mm from the opposite end of the glass tube (10). In this position, the inner mandrel protrudes 15 mm from both ends of the glass tube (10).

In a next step, the reforming tool (30) is once again moved perpendicular to the longitudinal axis of the glass tube (10) so that the reforming tool (30) exerts a compressive force on the outer surface of the glass tube (10) and presses it against the transport support, with a gas cushion being formed.

The reforming tool (30) is moved until the cross section of the glass tube attains a dimension of about 8 mm perpendicular to the surface of the shaped body. When the surfaces are configured suitably, precise plane-parallelism of the flat regions of the exterior and interior surfaces of the reformed tube (10) can be achieved.

This second forming step results in a formed glass tube (10) having a height of H=8 mm and a width of B=80 mm, corresponding to an aspect ratio of 10:1. The cross section of the reformed glass tube (10) corresponds substantially to the schematic depiction in FIG. 3a.

The person skilled in the art would be able to see that the invention is not restricted to the above-described figures and merely illustrative working examples, but can be varied in a variety of ways within the subject matter of the claims. In particular, the features of individual working examples can also be combined with one another. In addition, individual process steps of the process of the invention can advantageously be carried out a number of times in succession or can be supplemented by further process steps before, between or after the steps required according to the invention. The process steps also do not necessarily have to be carried out in the order indicated.

The preceding examples can be repeated with similar success by substituting the generically or specifically described components and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. Process for producing a glass tube having a cross section that deviates from a circular shape by reforming, comprising at least the steps:
providing a glass tube having a longitudinal axis, an inner surface and an outer surface,
heating of the glass tube,
providing at least one reforming tool, where the reforming tool is suitable for exerting a compressive force on the outer surface of the heated glass tube,
providing an inner mandrel which comprises at least one open-pored material,
inserting at least a section of the inner mandrel into the glass tube and
forming the heated glass tube by application of the compressive force perpendicular to the longitudinal axis of the glass tube,
where the compressive force is exerted by the reforming tool and acts on the outer surface of the glass tube
and where the glass tube does not rotate around its longitudinal axis.

2. Process according to claim 1, characterized in that the inner mandrel has a surface polished to a mirror finish.

3. Process according to claim 1, wherein the open-pored material comprises graphite, isostatically pressed graphite, sintered ceramic and/or metal.

4. Process according to claim 1, wherein the open-pored material has an open porosity in the range from 1% to 50%.

5. Process according to claim 1, wherein the inner mandrel has in its interior at least one hollow structure through which a gas can be introduced into the inner mandrel, with the gas flowing through the open-pored material to an exterior surface of the inner mandrel, forming a gas cushion between the surface of the inner mandrel and the interior surface of the glass tube.

6. Process according to claim 5, characterized in that the gas comprises at least one of the gases nitrogen or argon.

7. Process according to claim 5, wherein the gas is preheated to a temperature of from 200° C. to 800° C. before being introduced into the inner mandrel.

8. Process according to any claim 1, characterized in that the glass tube has a circular or an elliptical cross section before heating.

9. Process according to claim 1, characterized in that the glass tube is heated to a temperature that corresponds at least to the upper cooling point and not more than the softening point of the glass.

10. Process according to claim 1, characterized in that at least one further step of forming of the heated glass tube is carried out using at least one further inner mandrel, where the further inner mandrel deviates in terms of its cross-sectional geometry from the inner mandrel previously used.

11. Process according to claim 1, characterized in that a compressive force is applied before the introduction of the inner mandrel.

12. Process according to claim 1, wherein the aspect ratio of the cross section of the glass tube after forming is greater than the aspect ratio of the cross section of the glass tube before forming and is greater than 3:1.

13. Process according to claim 1, wherein the aspect ratio of the cross section of the glass tube after forming is greater than the aspect ratio of the cross section of the glass tube before forming and is greater than 6:1.

14. Process according to claim 1, wherein the aspect ratio of the cross section of the glass tube after forming is greater than the aspect ratio of the cross section of the glass tube before forming and is greater than 9:1.

15. A component for a housing of a mobile electronic device comprising a glass tube prepared by the method of claim 1.
